(19) United States
(12) Patent Application Publication
(10) Pub. No.: US 2019/0107625 A1
(43) Pub. Date: Apr. 11, 2019

(54) SCANNING LASER RADAR

(71) Applicant: HON HAI PRECISION INDUSTRY CO., LTD., New Taipei (TW)

(72) Inventors: HO-CHIANG LIU, New Taipei (TW); CHAO-TSANG WEI, New Taipei (TW); JUIN-HONG LIN, New Taipei (TW); GA-LANE CHEN, Santa Clara, CA (US)

(21) Appl. No.: 15/887,892

(22) Filed: Feb. 2, 2018

(30) Foreign Application Priority Data
Oct. 10, 2017 (CN) 201710934834.3

(51) Int. Cl. G01S 17/42; G01S 7/481; G01S 7/491; H01S 3/086

(52) U.S. Cl. CPC G01S 17/42; G01S 7/4811; H01S 3/10; G01S 7/4917; H01S 3/086; G01S 7/4911

(57) ABSTRACT

A scanning laser radar comprises a transmitting unit comprising a laser and a first lens; a receiving unit comprising a second lens and a light sensor; an actuating unit, wherein the laser and the light sensor are located on the actuating unit, the actuating unit carries and moves with the laser and the light sensor.

### CROSS-REFERENCE TO RELATED APPLICATIONS

This application claims all benefits accruing under 35 U.S.C. § 119 from China Patent Application No. 201710934834.3, filed on Oct. 10, 2017, in the China Intellectual Property Office, in the China Intellectual Property Office. Disclosures of the above-identified applications are incorporated herein by reference.

### FIELD

The present application relates to a scanning laser radar.

### BACKGROUND

With rapid development in the field of aerospace, scanning laser radars have been widely used in many measurement methods, such as non-contact atmospheric composition measurement, wind field data measurement, distance measurement, speed measurement and image target recognition.

Generally, a scanning laser radar includes a laser and a lens. The laser and lens are packaged together in a scanning device. The scanning device can be scanning mirrors, MEMS mirrors, etc. However, the lens is typically packaged with the laser, replacement of only the lens is often difficult and not efficient. Thus, the single scanning device can only achieve a single scanning requirement, which limits the application of scanning laser radar.

What is needed, therefore, is to provide a scanning laser radar that can overcome the above-described shortcomings.

### BRIEF DESCRIPTION OF THE DRAWINGS

Implementations of the present disclosure will now be described, by way of example only, with reference to the attached figures, wherein:

FIG. 1 is a schematic view of one exemplary embodiment of a scanning laser radar.

FIG. 2 is a schematic view of one exemplary embodiment of two scanning laser radars arranged on x-axis and y-axis, respectively.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

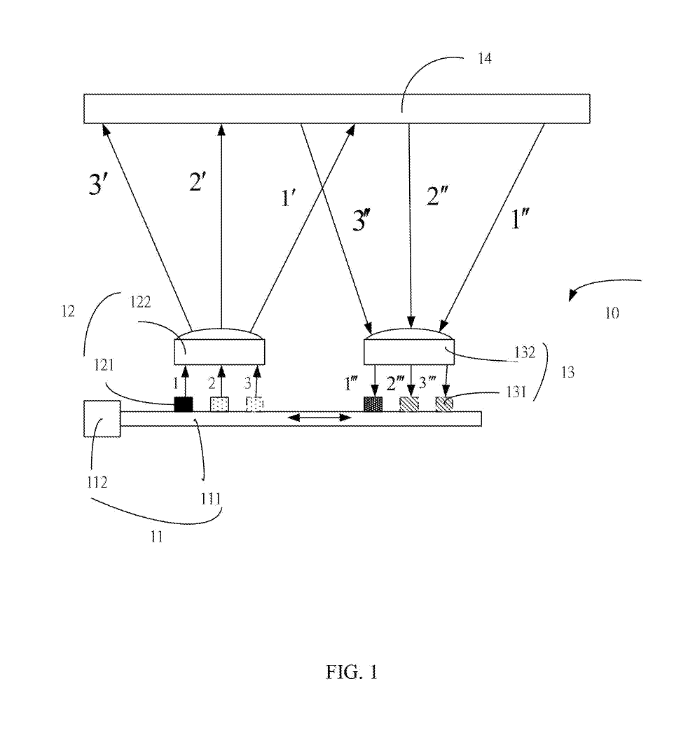

Referring to FIG. 1, one exemplary embodiment of a scanning laser radar 10 is provided. The scanning laser radar 10 includes an actuating unit 11, a transmitting unit 12 and a receiving unit 13. The transmitting unit 12 includes a laser 121 and a first lens 122. The first lens 122 receives light beam emitted by the laser 121. The receiving unit 13 includes a light sensor 131 and a second lens 132. The laser 121 and the light sensor 131 are spaced apart from each other and both located on the actuating unit 11. When the actuating unit 11 is displaced, the laser 121 also is displaced relative to the first lens 122, and the light sensor 131 is also displaced relative to the second lens 132.

Light beam 1 emitted by the laser 121 enters the first lens 122 and then emits from the first lens 122 to form a first emitted light beam 1′. The first emitted light beam 1′ is reflected by a measuring object 14 to form a reflected light beam 1″. The reflected light beam 1′ enters the second lens 132 and emits from the second lens 132 to form a second emitted light beam 1′″, and the second emitted light beam 1′″ is received by the light sensor 131.

A structure of the actuating unit 11 is not limited as long as the laser 121 and the light sensor 131 can be carried by the actuating unit 11. The actuating unit 11 can be a screw pushing device. Preferably, the actuating unit 11 carries and moves uniaxially with the laser 121 and the light sensor 131. In one exemplary embodiment, the actuating unit 11 includes an actuator 112 and a substrate 111 mounted on one end of the actuator 112. When the actuator 112 moves the substrate 111, the laser 121 and the light sensor 131 move in synchronization.

The actuator 112 moves the substrate 111 in a uniaxial manner. The substrate 111 supports the laser 121 and the light sensor 131. Structure of the substrate 111 and material of the substrate 111 are not limited to the examples provided herein. In one exemplary embodiment, the structure of the substrate 111 is a plate, and the material of the plate is plastic. The actuator 131 can be a voice coil actuator, a relay, a piezoelectric ceramic motor, or the like. In one exemplary embodiment, the actuator has a reciprocating motion along a single axis.

The laser 121 is located on the actuating unit 11. The laser 121 emits light beam. The laser 121 is not limited to only one type. The laser 121 can be a solid-state laser, such as a semiconductor laser, a neodymium-doped yttrium aluminium garnet laser (Nd: YAG laser) or the like. In one exemplary embodiment, the laser 121 is a Nd: YAG laser. The Nd: YAG laser is located on the substrate 111.

The first lens 122 is arranged corresponding to the laser 121 and the first lens 122 is fixed by a first support body (not shown). Structure of the first support body is not limited. In one exemplary embodiment, the first support body is a plastic support frame. The first lens 122 is located above the laser 121 and spaced apart from the laser 121. The first lens 122 receives the light beam 1 and changes exit angle of the first emitted light beam 1′. The first lens 122 can be a lens that may be used to image or project. Material of the first lens 122 is not limited. The first lens 122 can be made of plastic or glass.

The first lens 122 can be changed according to specific needs. In order to realize different scanning ranges, the first lens 122 can be changed to a lens with a different viewing angle.

The light sensor 131 is located on the actuating unit 11. The light sensor 131 receives the second emitted light beam 1′″ and converts optical signal of the second emitted light beam 1′″ into an electrical signal. The light sensor 131 is not limited to only one type. The light sensor 131 can be an avalanche photodiode (APD), a semiconductor photodiode (PD) or a time-of-flight sensor (ToF). In one exemplary embodiment, the light sensor 131 is the time-of-flight sensor. The time-of-flight sensor is located on the substrate 111. The light sensor 131 and the laser 121 are spaced apart from each other on the substrate 111.

The second lens 132 is disposed corresponding to the light sensor 131 and the second lens 132 is fixed by a second support body (not shown). Structure of the second support body is not limited. In one exemplary embodiment, the second support body is the same as the first support body. The second lens 132 is located above the light sensor 131 and spaced apart from the light sensor 131. The second lens 132 receives the reflected light beam 1″ and the reflected light beam 1″ emits by the second lens 132 to form a second emitted light beam 1″. An exit angle of the second emitted light beam 1′″ is in the same as an exit angle of the light beam 1. The second lens 132 and the first lens 122 have the same optical characteristics. The second lens 132 and the first lens 122 should have a same viewing angle. The second lens 132 can be a lens that may be used to image or project. Material of the second lens 132 is not limited. The second lens 132 can be made of plastic or glass.

The scanning laser radar 10 further includes an information processing system (not shown). The information processing system is a computer-based processing system. The information processing system can process and analyze information obtained by the light sensor 131 to calculate distances between the measuring object 14 and the scanning laser radar 10.

The actuating unit 11 is configured to move objects. In one exemplary embodiment, the actuating unit 11 carries and moves with the laser 121 and the light sensor 131. Because the first lens 122 and the second lens 132 is fixed , the laser 121 moves relative to the first lens 122, and the light sensor 131 moves relative to the second lens 132. When the laser 121 moves, light beams 1, 2, 3 emitted successively from the laser 121 enter the first lens 122 from different positions of the first lens 122, and emit to form a plurality of first emitted light beams 1′, 2′, 3′ through the first lens 122. The plurality of first emitted light beams 1′ , 2′, 3′ have different exit angles. The plurality of first emitted light beams 1′, 2′, 3′ are reflected from the measuring object 14 to form a plurality of reflected light beams 1″, 2″, 3″ with different reflected angles. The reflected light beams 1″, 2″, 3″ emit from the second lens 132 to form a plurality of second emitted light beams 1′″, 2′″, 3′″. The plurality of second emitted light beams 1′″, 2′″, 3′″ are received by the light sensor 131. The scanning laser radar 10 may help to achieve three-dimensional scanning of the measuring object 14.

The second emitted light beam 1′″ is parallel to the light beam 1 emitted by the laser 121, the second emitted light beam 2′″ is parallel to the light beam 2 emitted by the laser 121, and the second emitted light beam 3′″ is parallel to the light beam 3 emitted by the laser 121.

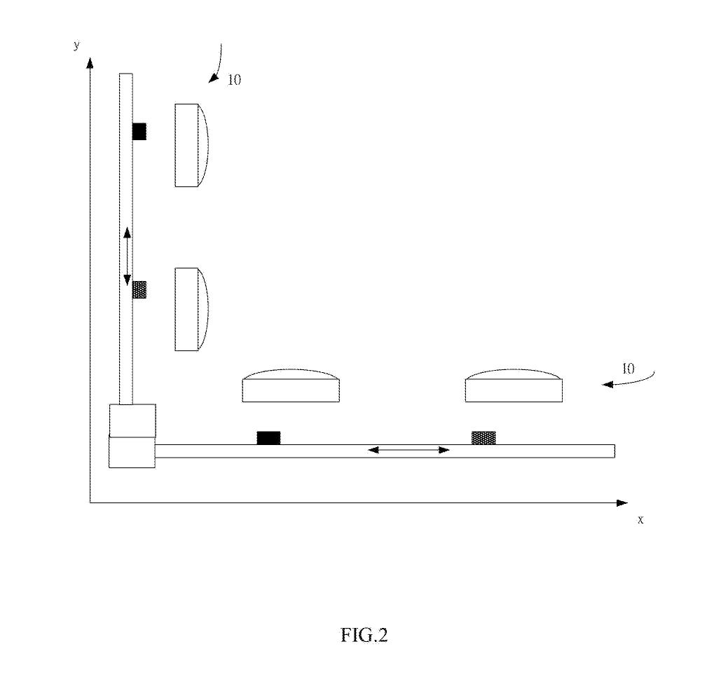

Moreover, a plurality of the scanning laser radars 10 can be set in different directions simultaneously. The plurality of scanning laser radars 10 simultaneously work to realize multi-line scanning. The plurality of scanning laser radars 10 scan more point positions of the surface of the measuring object 14, which may allow for more accurate measurement. In one exemplary embodiment, referring to FIG. 2, in an xyz Cartesian coordinate system, the scanning laser radar 10 is arranged on the x-axis and the y-axis, and the two scanning laser radars 10 scan simultaneously.

The scanning laser radar 10 includes an actuating unit 11, the actuating unit 11 carries and move the laser 121 and the light sensor 131 to allow light beam to irradiate the surface of the measuring object 14 from different angles, thus achieve three-dimensional scanning. Moreover, because the first lens 122 and the laser 121 are separately arranged; and the second lens 132 and the light sensor 131 are separately arranged, thus in order to meet requirement of multiple different scanning ranges, the first lens 122 and the second lens 132 can be changed to other lens with different viewing angles. In addition, a plurality of scanning laser radars 10 can be set in different directions simultaneously to achieve multi-line scanning. The scanning laser radar 10 can be used in the fields of 3D mapping, instant locations and map construction systems, advanced driver assistance systems, automatic vehicle systems, robots and driverless aircrafts.

The embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Additionally, it is also to be understood that the above description and the claims drawn to a method may include some indication in reference to certain steps. However, the indication used is only to be viewed for identification purposes and not as a suggestion as to an order for the steps.

What is claimed is:

1. A scanning laser radar comprising:
a transmitting unit comprising a laser and a first lens, wherein the laser emits a light beam, the first lens receives the light beam and then emits the light beam from the first lens to form a first emitted light beam, the first emitted light beam is reflected from a measuring object to form a reflected light beam; and
a receiving unit comprising a second lens and a light sensor, wherein the reflected light beam enters the second lens and exits from the second lens to form a second emitted light beam, the second emitted light beam is received by the light sensor;
an actuating unit, wherein the laser and the light sensor are located on the actuating unit, the actuating unit carries and moves with the laser and the light sensor.

2. The scanning laser radar of claim 1, wherein the actuating unit carries and moves uniaxially with the laser and the light sensor.

3. The scanning laser radar claim 1, wherein the actuating unit comprises an actuator and a substrate mounted on one end of the actuator, and the actuator moves the substrate.

4. The scanning laser radar of claim 3, wherein the actuator is a voice coil actuator, a relay, or a piezoelectric ceramic motor.

5. The scanning laser radar of claim 1, wherein the first lens is arranged corresponding to the laser and the first lens is fixed by a first support body.

6. The scanning laser radar of claim 1, wherein the second lens is arranged corresponding to the light sensor and the first lens is fixed by a second support body.

7. The scanning laser radar of claim 1, wherein the light sensor is avalanche photodiode (APD), a semiconductor photodiode (PD) or a time-of-flight sensor (ToF).

8. The scanning laser radar of claim 1, wherein the first lens and the second lens are replaced with lens with different viewing angles.

9. A scanning laser radar group comprising a plurality of scanning laser radars, wherein each of the plurality of scanning laser radars comprising:
a transmitting unit comprising a laser and a first lens, wherein the laser emits a light beam, the first lens receives the light beam and then emits the light beam from the first lens to form a first emitted light beam, the first emitted light beam is reflected from a measuring object to form a reflected light beam; and
a receiving unit comprising a second lens and a light sensor, wherein the reflected light beam enters the second lens and exits from the second lens to form a second emitted light beam, the second emitted light beam is received by the light sensor;
an actuating unit, wherein the laser and the light sensor are located on the actuating unit, the actuating unit carries and moves with the laser and the light sensor.

10. The scanning laser radar of claim 9, wherein the plurality of scanning laser radars scan synchronously.
